(19) United States
(12) Patent Application Publication
(10) Pub. No.: US 2006/0087930 A1
(43) Pub. Date: Apr. 27, 2006

(54) Optical disc apparatus

(75) Inventor: Gerard Eduard Rosmalen, Mierlo (NL)

Correspondence Address: PHILIPS INTELLECTUAL PROPERTY & STANDARDS, P.O. BOX 3001, BRIARCLIFF MANOR, NY, 10510, US

(73) Assignee: koninlike phillips electronics nv

(21) Appl. No.: 10/527,869

(22) PCT Filed: Aug. 13, 2003
(86) PCT No.: PCT/IB03/03636

§ 371 Date: Mar. 16, 2005

(30) Foreign Application Priority Data
Sep. 19, 2002 (EP) 02078880.8

(51) Int. Cl. G11B 7/00

(52) U.S. Cl. 369/44.14; 369/44.17

(57) ABSTRACT

An optical disc apparatus (1) comprising a supporting assembly (7), a spindle motor (9) having a magnetic motor stator (17), optical means for scanning an information surface of said optical disc mounted on the spindle and comprising a focusing lens assembly (29) having a movable focusing lens, a swing arm assembly (41) comprising a generally elongated swing arm structure (43) mounting said focusing lens assembly adjacent to a free end (41), movable magnetic scanning means provided at the free end of the swing arm assembly for driving said swing arm assembly rotationally about a swing axis (47) for scanning the disc information surface and stationary magnetic scanning means associated with the supporting assembly and comprising a magnetic scanning stator core (59) provided near and spaced from the free end of the swing arm assembly for magnetically cooperating with said movable magnetic scanning means through at least one intermediate air gap disposed in a curved plane. The stationary magnetic scanning means are rigidly associated with the magnetic motor stator.

Optical disc apparatus for recording and/or reproducing information on/from an information surface of a rotatable optical disc, comprising:

a supporting assembly;

a motor, associated with the supporting assembly, for rotating the optical disc about a spindle axis and having a magnetic rotor and a magnetic motor stator magnetically cooperating with each other across an intermediate air gap;

optical means associated with the supporting assembly for scanning an information surface of said optical disc and comprising a focusing lens assembly having a movable focusing lens having a focusing axis, said focusing lens assembly being movable in an axial direction along said focusing axis for focusing an optical beam on said information surface of said optical disc (5);

a swing arm assembly comprising a generally elongated swing arm structure mounting said focusing lens assembly near a free end, the swing arm assembly being pivotally rotationally movable about a swing axis remote from said free end and directed generally perpendicularly to the swing arm structure and generally parallel to said spindle axis and said focusing axis, such that the swing arm assembly rotationally sweeps a scanning plane generally parallel to said information surface of the mounted optical disc, the swing arm assembly thereby causing said focusing lens assembly to scan over the information surface of the mounted optical disc;

rotational pivoting means for enabling said rotational scanning movements of the swing arm assembly and comprising stationary pivoting means associated with the supporting assembly and movable pivoting means associated with the swing arm structure pivotally cooperating with the stationary pivoting means;

movable magnetic scanning means provided at the free end of the swing arm assembly for driving said swing arm assembly rotationally about said swing axis;

stationary magnetic scanning means associated with the supporting assembly and comprising a magnetic scanning stator core provided near and spaced from the free end of the swing arm assembly for magnetically cooperating with said movable magnetic scanning means across at least one intermediate air gap disposed in a curved plane.

An embodiment of such an optical disc apparatus is known from U.S. Pat. No. 4,794,586 disclosing a swing arm assembly in which the movable magnetic focusing means and the movable magnetic scanning means comprise two voice coils arranged at the free end of the swing arm assembly, whose windings are crossed to provide both focusing and scanning movements in cooperation with stationary permanent magnetic stator means. The swing arm assembly is pivotally movable about a swing axis which is the central axis of a stationary pivot. To focus the focusing lens, the arm assembly is flexed as a whole by the magnetic focusing force produced by the voice coils provided at the free end of the arm assembly.

The accuracy of scanning movements of the swing arm assembly relative to the information surface of an optical disc which has been placed on a disc support provided on the motor spindle with this kind of prior art optical disc apparatus is dependent on a number of positional and angular tolerances in regard to e.g. the relative positions of the motor spindle, the rotational pivoting means for the swing arm assembly and the position of the stationary magnetic stator means and their angular relative orientations. The motor unit, the swing arm assembly and the stationary magnetic stator means all have to be individually positioned and secured by suitable means relative to the supporting assembly, for example a base plate or frame. As a result of the constant trend for miniaturization, which may be observed in the information and communication industry in general, optical disc apparatus are getting ever smaller. As a result the tolerances indicated above for positioning parts on a supporting assembly also have to become smaller, thus increasing the complexity of the manufacturing of the individual parts as well as the assembly of the parts.

It is therefore an object of the invention to provide a novel and useful optical disc apparatus of the above kind which is easier to produce and assemble, which is suitable for but not limited to miniaturized optical disc apparatus and is adaptable to several interesting and advantageous embodiments. With this object in mind the invention provides an optical disc apparatus of the kind described, having the inventive feature that the stationary magnetic scanning means are rigidly associated with the magnetic motor stator.

Thus any inaccuracies in the position of the stationary magnetic scanning means and the motor stator resulting from individual positioning on a supporting assembly are eliminated. The accurate positioning of the stationary magnetic means relative to the motor stator means may be carried out by the motor manufacturer during the production of the motor under accurately controlled conditions.

Preferably an embodiment of the invention is used wherein the motor stator and the scanning stator core are integrated into a combined stationary unit. Thus the motor stator and the scanning stator core may be manufactured by the motor manufacturer as an integrated unit, eliminating the need to secure and position a separate scanning stator core to the spindle motor.

Preferably a further embodiment of the invention is used, wherein also the stationary pivoting means are rigidly associated with the magnetic motor stator. This eliminates securing and positioning of the stationary pivoting means.

Preferably another embodiment of the invention is used wherein the motor stator, the scanning stator core and the stationary pivoting means are integrated into a combined stationary unit.

Advantageously, an embodiment is used wherein the optical disc apparatus further comprises:

focusing guide means for enabling the axial focusing movements of the focusing lens assembly along said focusing axis;

movable magnetic focusing means provided at the free end of the swing arm assembly for axially driving said focusing lens assembly along said focusing axis for focusing the optical beam on the disc information surface;

stationary magnetic focusing means associated with the supporting assembly and comprising a magnetic focusing stator core provided near and spaced from the free end of the swing arm assembly for magnetically cooperating with said movable magnetic focusing means across at least one intermediate air gap disposed in a curved plane; wherein the stationary magnetic focusing means are rigidly associated with the magnetic motor stator.

An embodiment of the invention is preferred, wherein the motor stator, the scanning stator core, the stationary pivoting means and the focusing stator core are all integrated into a single combined stationary unit. Thus all the securing and positioning work normally required to secure and position the scanning stator core, the stationary pivoting means and the focusing stator core relative to each other and to the spindle motor are eliminated.

In many cases spindle motors for modern small-size optical disc apparatus are provided with a spindle motor comprising a stationary motor spindle inserted in a supporting means such as a base plate, a permanent-magnet rotor being assembled over the spindle. The motor stator is assembled as a stack of individual mutually isolated stator plates which have been cut so as to provide stator teeth on the inside on which stator coils are wound by special machines. The stator is placed over the motor rotor and is centered relative to the rotor by centering means provided on the supporting means.

With this or similar kinds of spindle motor an embodiment of the invention may be used to advantage, wherein the combined stationary unit comprises a scanning stator packet assembled from magnitizable individual stator laminations. In this embodiment the individual stator plates are cut with a motor stator part and a scanning stator part as one piece.

A further important embodiment of the invention is highly suitable for use to advantage with a motor stator of this or similar kind, wherein:

the movable magnetic scanning means comprise permanent-magnet rotationally movable scanning means,

the stationary magnetic scanning means comprise a number of individual stator coils arranged on the stator core in a serial arrangement along the rotational scanning path of the movable permanent-magnet scanning means,

electronic commutating means being provided to selectively switch stator coils on and off,

scanning sensor means being provided for detecting, and scanning control means being provided for controlling the rotational position of the arm structure respectively, by controlling the current amplitude and direction in each of the stator coils which has been selectively switched on in order to control the rotational arm position and movements.

In this embodiment the scanning stator coils may be provided on the scanning stator core using the same machine that provides the motor stator coils on the motor stator, thus minimizing the assembly effort for assembling the scanning stator coils on the scanning stator core.

A further interesting embodiment of the invention has the feature that:

the movable magnetic focusing means comprise permanent-magnet axially movable focusing means and

the stationary magnetic scanning means and the stationary magnetic focusing means comprise a number of individual stator coils arranged on the stator core in a serial arrangement along the rotational scanning path of the movable permanent-magnet scanning means and distributed over two axially spaced levels,

focusing sensor means being provided for detecting, and focusing control means being provided for controlling the axial focusing lens position respectively by controlling the current amplitude and direction in each of the stator coils which has been selectively switched on in order to control the axial focusing lens position and movements.

With this embodiment the movable magnetic scanning means as well as the movable magnetic focusing means are permanent magnetic means. This has the obvious advantage that no electrical coils have to be provided on the swing arm structure, thus eliminating the need to provide electrical connecting lines to any coils on the pivotally rotating swing arm structure. All the coils, for scanning as well as focusing, are on the stationary unit associated with or even integrated with the motor stator and may be provided by the motor manufacturer.

An operational interesting embodiment of an optical disc apparatus of the latter kind may have the feature that

the stator coils in each of the two levels are spaced at a constant pitch on the stator core along the path rotationally swept by the movable magnetic scanning means and movable magnetic focusing means,

the stator coils in the two levels are arranged in planes parallel to the scanning plane of the scanning arm structure and

the stator coils present in one level are positioned between the stator coils present in the other level.

By suitable control of the currents in the coils on the stator core which have been selectively switched on, the focusing lens assembly may be controlled both in the scanning direction and in the focusing direction for following a track on the information surface of a rotating optical disc with the laser spot emanating from the focusing lens. Suitable control of the commutating means may further provide scanning movements of larger amplitude from one area on the information disc to a further area spaced a distance apart.

In cases where the movable scanning and/or focusing means are permanent-magnet means, a further interesting embodiment of the invention may be used wherein biasing means are provided to bias the magnetic force of attraction produced between the movable permanent-magnet scanning and/or focusing means and the motor stator, whereby magnetic adhesion of the scanning arm structure to the motor stator is prevented in a rotationally extreme position of the scanning arm structure nearest to the spindle motor. This will prevent magnetic adhesion of the scanning arm structure against the motor stator, which may be too strong to overcome by the scanning stator coils.

An advantageous embodiment which provides the said biasing means without adding any separate parts to the optical disc apparatus has the feature that:

the stator core is provided with stator teeth,

the stator coils are wound on the stator teeth, and

the biasing means are provided by one or more stator teeth on said stator core, positioned in such a way that in said extreme rotational position of the scanning arm structure the rotational magnetic pull of said one or more stator teeth exceeds the rotational magnetic pull of the motor stator.

Also provided is an interesting further alternative embodiment of the invention, wherein:

the movable magnetic scanning means comprise a cylindrical scanning coil having a generally rectangular shape in cross section and having a central opening, two pairs of parallel outer side surfaces, two pairs of inner side surfaces and outwardly facing axial end surfaces at the axially spaced ends of the coil,

the movable focusing means comprising two cylindrical focusing coils which have a generally rectangular shape in cross-section and have a central opening, two pairs of parallel outer side surfaces, two pairs of inner side surfaces and outwardly facing axial end surfaces at the axially spaced ends of the coil,

the scanning coil being bonded with one of its outer side surfaces against the free end of the swing arm structure in a position with its central axis generally parallel to the scanning movements of the swing arm,

each focusing coil being bonded at a part of one of its outwardly facing axial end surfaces on one side of its central opening against the outer side surface of the scanning coil which is remote from the swing arm structure, the two focusing coils being disposed such that said parts of their outwardly facing axial end surfaces are near to each other, parallel to each other and generally parallel to the scanning movements of the swing arm,

the combined stationary magnetic means comprising an elongated permanent-magnet means facing the movable focusing coils and spaced from the focusing coils by said air gap, and further comprising a magnetically permeable stator supporting the permanent-magnet means and having a stator part passing through the central opening of the scanning coil with play, the permanent magnet means being magnetically polarized in a radial direction relative to the swing axis of the swing arm assembly and the arrangement being such that a substantially radially directed permanent magnetic field is set up across said air gap.

With this embodiment it is the stationary scanning means and focusing means that are permanently magnetic, which may be preferred in some cases. A single combined permanent-magnet stationary magnetic means is provided on the magnetically permeable stator which may be integrated with the motor stator as before and may be comprised of a stack of individual stator plates as before, etc. A very efficient light weight coil arrangement is provided on the movable arm structure for scanning as well as focusing.

The objects and features of the present invention will become more apparent by referring to the following non-limiting description of a few preferred embodiments given with reference to the accompanying drawings in which:

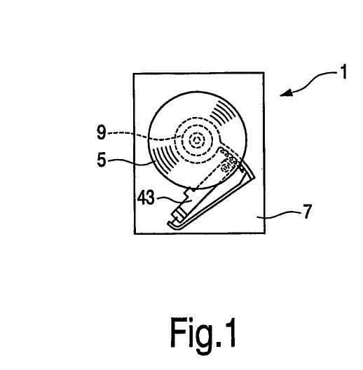

FIG. 1 is a schematic plan view of an optical disc apparatus of miniaturized dimensions,

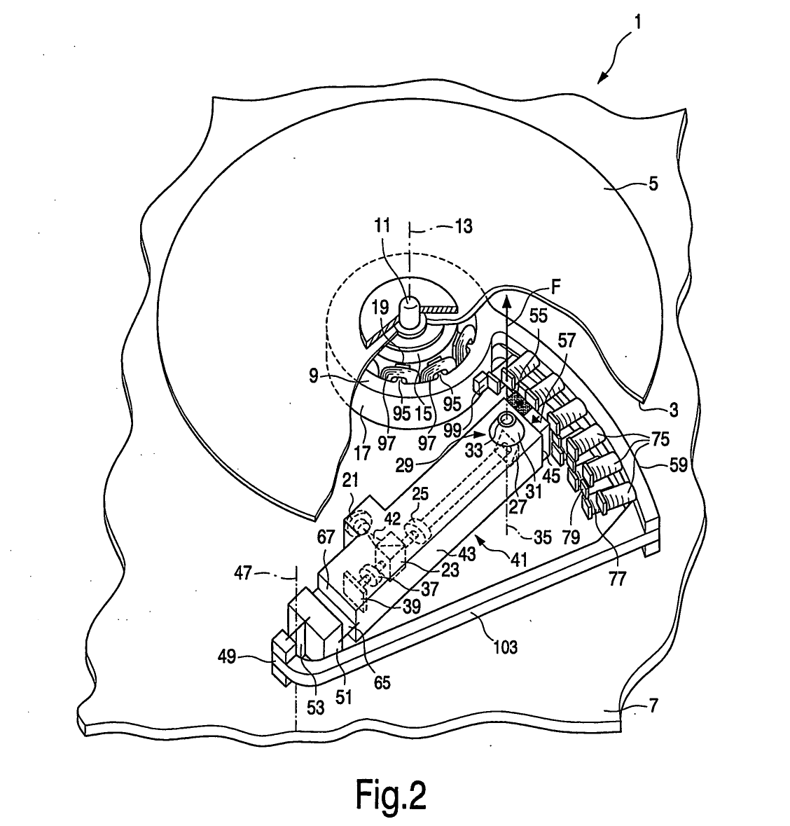

FIG. 2 is a schematic perspective fragmentary view of the optical disc apparatus of FIG. 1,

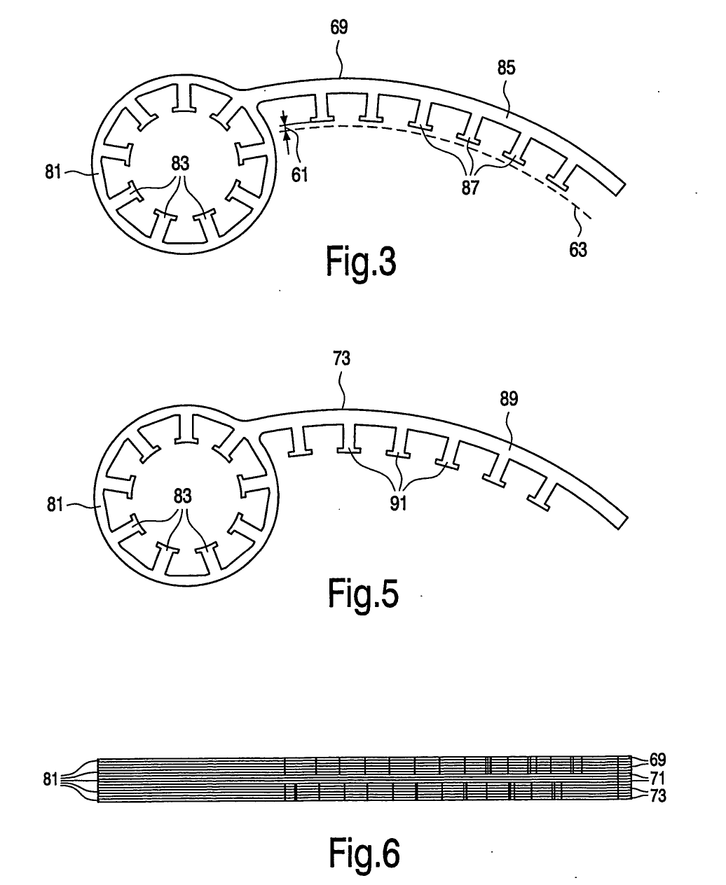

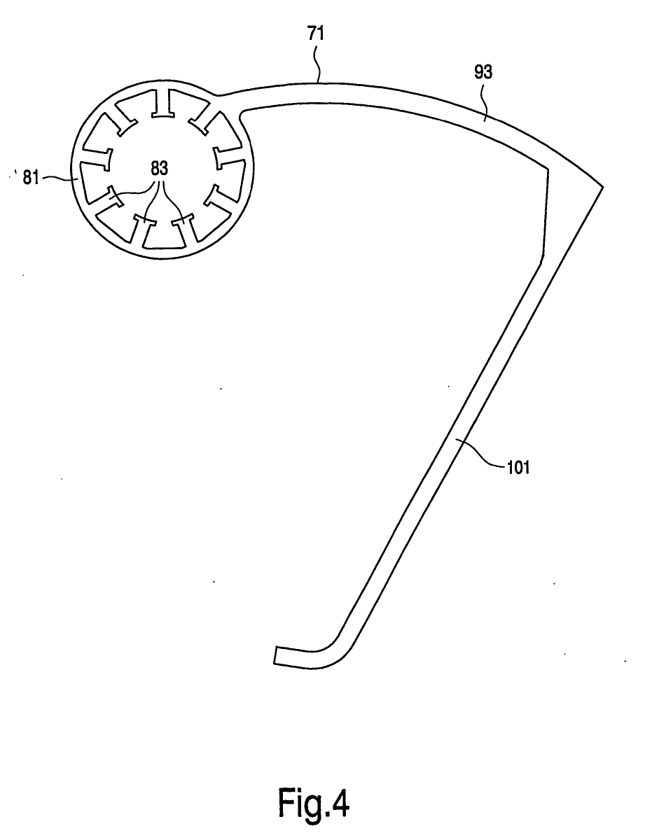

FIGS. 3-5 are plan views of individual stator laminations of the combined motor and focusing/scanning stator of the optical disc apparatus of FIGS. 1-2,

FIG. 6 is a side view of a stack of stator laminations shown individually in FIGS. 3-5,

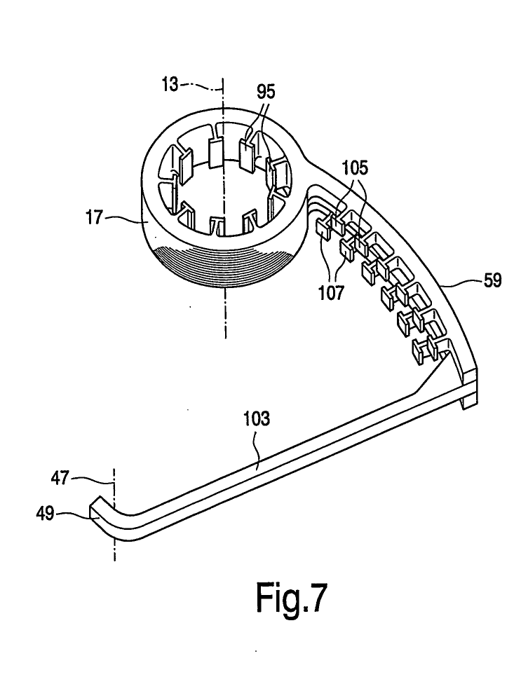

FIG. 7 is a perspective view of the stacked stator laminations from FIG. 6,

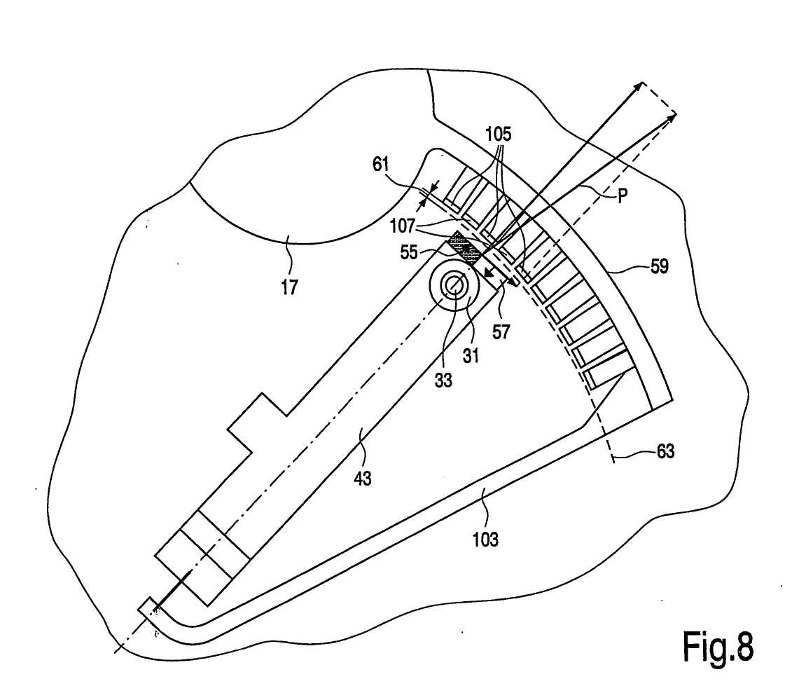

FIG. 8 is a fragmentary plan view illustrating alternative biasing means to bias a swing arm structure magnetically away from a spindle motor stator,

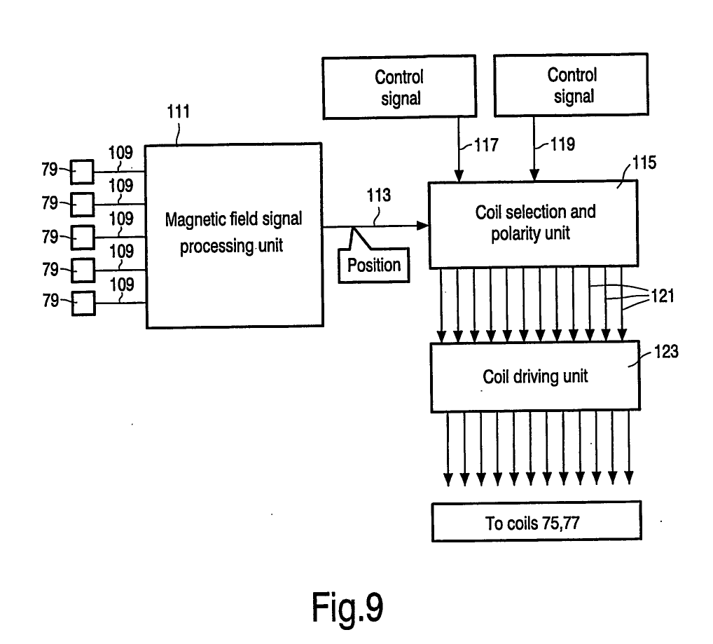

FIG. 9 is a block diagram of the electronic circuitry for the course and fine control of the rigid swing arm focusing and scanning positions,

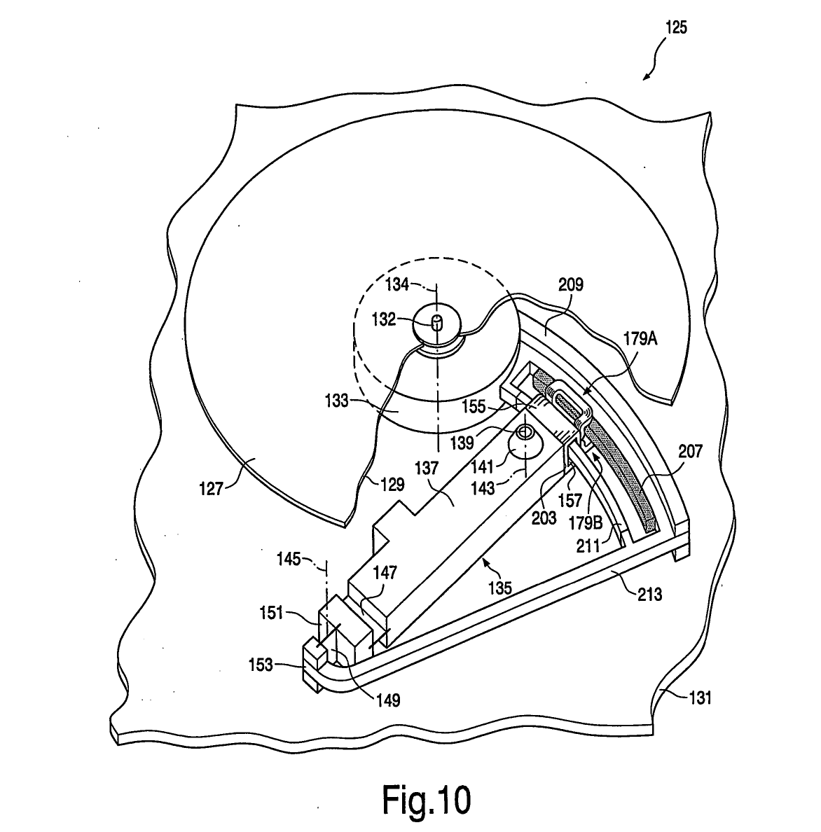

FIG. 10 is a schematic perspective view similar to FIG. 2 but of an alternative embodiment of an optical disc apparatus and

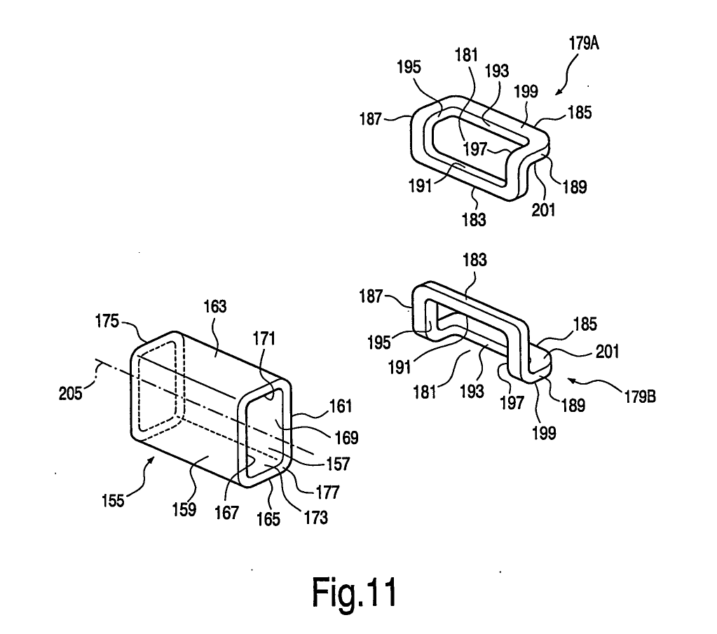

FIG. 11 is a perspective exploded view of the arrangement of electrical coils used to control the rigid swing arm scanning and focusing movements of the optical disc apparatus of FIG. 10.

Referring to FIGS. 1 and 2 of the drawing, an optical disc apparatus 1 is shown for recording and/or reproducing information on/from an information surface 3 of a rotatable optical disc 5. The optical disc apparatus 1 is of miniaturized dimensions and is shown in FIG. 1 to approximately true scale. The optical disc has a diameter of the order of 23 mm.

The optical disc apparatus 1 comprises a supporting assembly 7 which in the embodiment shown is a printed circuit board measuring some 30×40 mm. A spindle motor 9 is associated with the supporting assembly 7 and has a spindle 11 with a spindle axis 13 for rotating the optical disc 5 mounted on the spindle 11 about the spindle axis 13. The spindle motor 9 comprises a permanent magnetic rotor 15 and a magnetic motor stator 17, magnetically cooperating with each other across an intermediate air gap 19.

Optical means are associated with the supporting assembly 7 for scanning the information surface 3 of the optical disc 1 mounted on the spindle 11. The optical means comprise a diode laser unit 21, a beam splitter 23, a collimator lens 25, a 90° reflecting element 27, a focusing lens assembly 29 comprising a lens mount 31 and a movable focusing lens 33 having a focusing axis 35, the focusing lens assembly 29 being movable in an axial direction along focusing axis 35. The optical means further comprise a so-called servo lens 37 and a photosensitive array 39. All these optical elements are well known to those skilled in the art of optical disc equipment and will not be explained in detail here. The photodiode laser unit 21 emits a laser beam 42 which is split by the beam splitter 33. Part of the beam is directed to the 90° reflecting element 27 and is shaped by the collimator lens. The laser beam is reflected by the 90° reflecting element 27 and projected through the focusing lens 33 onto the information surface 3 of the optical disc 5. The beam modulated by the data present in the rotating disc 5 is reflected by the information surface 3 and returns through the focusing lens 33, is reflected by the 90° reflecting element 27, passes through the collimator lens 25 and at least partly through the beam splitter 23, and impinges on the photosensitive array 29. The output signals of the photosensitive array 29 are output to electronics circuits to derive the data signals representing the data read out from the information surface 3 of the optical disc 5 and to extract the error signals needed to control the position and the movements of the optical assembly relative to the information surface 3 of the optical disc 5.

The optical assembly 21-39 described above is provided in a swing arm assembly 41 comprising a generally elongate swing arm structure 43 mounting said focusing lens assembly 31-33 near a free end 45, the swing arm assembly 41 being pivotally rotationally movable about a swing axis 47 remote from said free end 45 and directed generally perpendicularly to the swing arm structure 42 and generally parallel to said spindle axis 13 and said focusing axis 35, such that the swing arm assembly 41 rotationally sweeps a scanning plane generally parallel to said information surface 3 of the mounted optical disc 5, the swing arm assembly thereby causing said focusing lens assembly 31-33 to scan over the information surface 3 of the mounted optical disc 5.

Rotational pivoting means 49-53 are provided for enabling said rotational scanning movements of the swing arm assembly 41, which means comprise stationary pivoting means 49 associated with the supporting assembly 7 and movable pivoting means 51 associated with the swing arm structure 43 pivotally cooperating with the stationary pivoting means 51. In the present embodiment, the stationary pivoting means 49 and the rotational pivoting means 51 are permanently connected to each other by a deflectable leaf spring 53, which allows pivoting movements of the swing arm assembly 41 in the scanning direction parallel to the information surface 3 of the optical disc 5 only.

Movable magnetic scanning means 55-57 are provided at the free end of the swing arm assembly 41 for driving the swing arm assembly rotationally about its swing axis 47. In the present embodiment, the movable magnetic scanning means comprise two adjacent permanent magnets 55 and 57 which have been fixed on the free end of the swing arm structure 43 by suitable means such as an adhesive. The permanent magnets 55, 57 are magnetized in parallel opposite directions (indicated by arrows in FIG. 2) basically along a magnetic axis parallel to the general extension of the swing arm assembly 41.

Stationary magnetic scanning means are provided, associated with the supporting assembly 7 and comprising a magnetic scanning stator core 59 provided near and spaced away from the free end of the swing arm assembly 41 for magnetically cooperating with the movable magnetic scanning means 55, 57 across an intermediate air gap 61 disposed in a curved plane 63 (see more particularly FIG. 3, which will be discussed below).

The embodiment of the invention shown in FIGS. 1-2 is of a kind in which the pivoting means 49-51 discussed above for enabling scanning movements of the swing arm assembly are second pivoting means, first pivoting means being provided for enabling focusing movements of said focusing lens assembly 29. These first pivoting means resemble the already discussed second pivoting means in that they comprise a leaf spring 65 which is fixed to an end part 67 of the swing arm structure 43 on one side and to the movable pivoting means 51. The movable pivoting means 51 thus form an intermediate element between the two leaf springs 53 and 65. The leaf spring 65 is oriented such that it will allow movements of swing arm structure 41 whereby the focusing lens 33 can move along the focusing axis 35 only.

The movable magnetic scanning means 55-57 also operate as movable magnetic focusing means provided near the said free end 45 of the swing arm assembly 41 for driving the focusing lens 33 along the focusing axis 35 to focus the optical beam 42 on the optical disc information surface 3 and thus form combined movable magnetic focusing/scanning means 55-57. Stationary magnetic focusing means are present, associated with the supporting assembly 7 for magnetically cooperating across the intermediate air gap 61 with the said combined movable magnetic focusing/scanning means 55-57 for generating a magnetic force vector having a vector component F parallel to the focusing axis 35 for driving the focusing lens assembly 29 along the focusing axis 35. These stationary magnetic focusing means are combined with the stationary magnetic scanning means and will be discussed below in connection with FIGS. 2-8.

A feature of the embodiment of the optical disc apparatus of FIGS. 1-2, which is the subject matter of a co-pending application PHNL020898 (Applicant's identification number), having the same priority date as the present application and which is herewith incorporated in the present application by reference, is that the swing arm structure 43 is rigid from the free end 45 to at least near the swing axis 47 and that the first pivoting means 51, 65, 67 are provided at or near the second pivoting means 49, 51, 53. The swing arm structure 43 is shown more particularly in FIG. 2 as a box-like structure housing the optical means 21-33, the lens mount 31 being a fixed element rigidly connected to the swing arm structure 43. However, alternative solutions may appear to those skilled in the art. The swing arm structure could for example be shaped as rigid profiled beam carrying the optical means 21-33 on the outside. Part of the optical means could be located outside the swing arm structure and communicate with the remaining means present on or in the swing arm structure through optical, electrical or other connections. The swing arm structure of the optical disc apparatus 1 of FIGS. 1-2 has very small dimensions of the order of 2×2×16 mm.

According to a feature of the present invention, the stationary magnetic scanning means or magnetic scanning stator core 59 is rigidly associated with the magnetic motor stator 17. In fact, in the embodiment of FIGS. 1-2, the motor stator 17 and the scanning stator core 59 are integrated into a combined stationary unit. Also, the stationary pivoting means 49 are rigidly associated with the magnetic motor stator 17. In fact, the motor stator 17, the scanning stator core 59 and the stationary pivoting means 49 are all integrated into a combined stationary unit. As has been discussed above, with the embodiment according to FIGS. 1-2, the stationary magnetic focusing means are combined with the stationary magnetic scanning means, so that in FIGS. 1-2 the motor stator, the scanning stator core, the stationary pivoting means and a focusing stator core are all integrated into a combined stationary unit.

Referring now more particularly to FIGS. 3-6, the combined stationary unit comprises a stator packet assembled from magnetizable individual stator laminations of three different kinds referred to by the reference numbers 69, 71 and 73 respectively. In the embodiment of the invention acording to FIGS. 1-2, the movable magnetic scanning means comprise permanent magnetic rotationally movable scanning means 55, 57, and the stationary magnetic scanning means comprise a number of individual stator coils 75 (six coils) arranged on the stator core 59 in a serial arrangement along the rotational scanning path of the movable permanent magnetic scanning means 55, 57. Electronic commutating means are provided (to be discussed later) to selectively switch individual stator coils 75 on and off, scanning sensor means 79 (five sensors) which are provided for detecting and scanning control means (to be discussed later) being provided for controlling the rotational position of the arm structure 43 by controlling the current amplitude and direction in each of the stator coils 75 that have been selectively switched on in order to control the rotational arm position and movements.

In the embodiment of the invention according to FIGS. 1-2, the movable magnetic focusing means comprise permanent magnetic axially movable focusing means also formed by the permanent magnets 55, 57, the stationary magnetic scanning means, and the stationary magnetic focusing means comprising a number of individual stator coils 75 (six coils) and 77 (six coils) arranged on the stator core in a serial arrangement along the rotational scanning path of the movable permanent magnetic scanning means 55, 57 and distributed over two axially spaced levels. Focusing sensor means are provided in the photosensitive array 39 for detecting the focusing position of the focusing lens 33 in the usual way. Focusing control means and scanning control means (to be discussed later on) are provided for controlling the axial focusing lens 33 position and the angular position of the swing arm assembly 41, respectively, by controlling the current amplitude and direction in each of the stator coils 75, 77 that have been selectively switched on in order to control the axial focusing lens position and movements. The stator coils 75, 77 in each of the two levels are spaced at a constant pitch on the stator core 59 along the path rotationally swept by the movable magnetic scanning means and movable magnetic focusing means 55, 57. The stator coils 75, 77 in the two levels are arranged in planes parallel to the scanning plane of the scanning arm structure and the stator coils 75 present in one level are positioned between the stator coils 77 present in the other level.

FIGS. 3-6 illustrate how both the motor stator core 17 of the spindle motor 9 and the scanning stator core 59 of the stationary magnetic scanning/focusing means may be assembled from individual stator laminations 69, 71 and 73. As is customary, the stator laminations consist of individual parts stamped from soft iron plate material, covered on both sides with an electrically insulating coating or film to prevent eddy currents from flowing between the individual laminations. Each of the laminations 69-73 is provided with an annular portion 81 provided with inwardly projecting, angularly evenly spaced teeth. Stator plates 69 are provided with a curved portion 85 extending from and integral with the annular part 81 and provided with mutually evenly spaced teeth 87. Stator plates 73 are similarly configured with a curved portion 89 having teeth 91 in positions offset from the teeth 87 but having the same mutual spacing or pitch.

Stator plates 73 are provided with a curved portion 93 configured similarly to the curved portions 85 and 89, but without teeth. The combined spindle motor/scanning stator is assembled by stacking, for example, six of the laminations 69 on three laminations 71 on six laminations 73, the teeth 83, 87 and 91 thus forming eight stator teeth 95 for eight motor stator coils 97, as well as six teeth for the six coils 75 and six teeth for the six coils 77 for the scanning stator core 59, respectively. The axial separation of the two rows of coils 75, 77 is provided by the intermediate laminations 93.

Biasing means 99 formed by a small permanent magnet are provided to bias the magnetic attraction force produced between the movable permanent magnetic scanning/focusing means 55, 57 and the motor stator 17, whereby magnetic adhesion of the scanning arm structure 43 to the motor stator 17 is prevented in a rotationally extreme position of the scanning arm structure 43 nearest to the spindle motor 9. The magnetic field of the permanent magnet 99 interacts with the magnetic fields of the permanent magnets 55, 57 in a repellant way such that the scanning arm structure 43 will be prevented from adhering magnetically to the spindle motor 9.

In the optical disc apparatus 1 according to the embodiment of FIGS. 1-2, the motor stator 17, the scanning/focusing stator core 59, as well as the stationary pivoting means 49 are all integrated into a combined stationary unit. Referring now more particularly to FIGS. 3-7, the laminations 71 are for this purpose provided with a further extension 101 at the free end of the curved portion 93 and at an appropriate angle to the curved portion 93 of, for example, approximately 90°. The stacked extensions 101 of the laminations 71 form a supporting beam, while the stacked laminations 69 and 73 form the mutually offset stator teeth 105 and 107 respectively, of the scanning stator core 59. The method of securing the leaf springs 53 and 65 between the swing arm structure 43 and the rotating pivoting means 51 and between the pivoting means 51 and the stationary pivoting means 49 at the free end of the supporting beam 103, respectively, has been shown only schematically in FIGS. 1-2. The leaf springs may be secured by any of a variety of methods known to those skilled in the art, such as by adhesive means, laser welding, spot welding, mechanical clamping, by screws or rivets, etc.

FIG. 8 is illustrative of an embodiment of the invention which has been slightly modified in comparison with the embodiment of FIGS. 1-7. Only those details will be discussed which are typical of this modified embodiment. The biasing means 99 are no longer required in this modified embodiment. Instead, the biasing means are provided by one or more stator teeth 105, 107 on the scanning stator core 59, positioned in such a way that in said extreme rotational position of the scanning arm structure 43 the rotational magnetic pull of said one or more stator teeth 105, 107 exerted on the rotating permanent magnetic scanning means 55, 57 exceeds the rotational magnetic pull of the motor stator 17. This is accomplished by widening the air gap 61 between stator teeth 55, 57 and the rotating permanent magnetic scanning means 55, 57 in the vicinity of the motor stator 17. As a result, the magnetic pull P exerted by the stator teeth 55, 57 will exceed the magnetic pull of the motor stator 17 in any position of the swing arm structure 43.

Referring now to the block diagram of FIG. 9, the electronic coarse and fine control of the rigid swing arm angular and focusing positions will be briefly discussed. The five magnetic field sensors 79, for example of the Hall sensor type or any other suitable type, sense the magnetic fields of the movable permanent magnetic scanning/focusing means 55, 57 and produce electrical magnetic field signals 109 representative of the magnetic field strength and direction sensed. The five signals 109 are input to a magnetic field signal processing unit 111 in which the swing arm angular and focusing position is determined. From this unit a swing arm position signal is output which is input to a coil selection and polarity unit 115. Also input to the coil selection and polarity unit are a focus control signal and tracking control signal 119. These signals are derived from the focus control and tracking control signals provided by the control circuitry (not shown) connected to the photosensitive array 39 which may be largely conventional. The focus control and tracking control signals are used for a fine tuning of the position of the laser beam spot produced by the focusing lens 33 relative to a track of the information surface 3 of the optical disc 5 of the optical disc apparatus 1. The coil selection and polarity unit 115 has twelve outputs 121, each connected to a respective one of the twelve coils 75, 77 of the stationary magnetic scanning means. The operation of the coil selection and polarity unit during normal operation of the optical disc apparatus 1 is such that only those coils are selected that are actively needed for the fine control of the swing arm position relative to the nominal current position of the swing arm relative to the tracks in the information surface 3 of the optical disc sensed by the magnetic field sensors 79. Only a selected few of the outputs 121 are switched on in any such nominal current position. These outputs are controlled by the coil selection and polarity unit in amplitude and polarity in a way suitable for achieving the necessary fine focusing and tracking control. The twelve outputs 121 from the coil selection and polarity unit are connected to twelve corresponding inputs of twelve coil driving circuits provided in a coil driving unit 123, which coil driving circuits amplify the output signals of the coil selection and polarity unit to a level suitable for generating the required magnetic fields in each of the selected coils 75, 77 which are active in the current arm position.

Different embodiments may be used with the invention. Referring now to FIG. 10, an embodiment will be described comprising an optical disc apparatus 125 with an optical disc having an information surface 129 and further comprising a supporting assembly 131. The dimensions may be similar to those of FIGS. 1-7, while a number of constituent parts are also similar and will therefore not be described in detail. A spindle motor 133 is provided for rotating the optical disc 127. A swing arm assembly 135 comprises a swing arm structure 137 comprising a number of optical components, such as the swing arm assembly 41 of FIG. 2, among them a focusing lens 139 mounted on a lens mount 141. The focusing lens 139 is movable along a focusing axis 143, and the swing arm assembly is pivotable about a swing axis 145 parallel to the focusing axis 143. Leaf springs 147 and 149 are provided for enabling pivoting focusing and scanning movements of the entire rigid swing arm structure 137 relative to an intermediate part 151 and stationary pivoting means 153, respectively. The movable magnetic scanning means comprise a cylindrical scanning coil 155 having a generally rectangular shape in cross-section and having a central opening 157, two pairs of parallel outer side surfaces 159, 161 and 163, 165, two pairs of inner side surfaces 167, 169 and 171, 173 and outwardly facing axial end surfaces 175, 177, respectively, at the axially spaced ends of the coil. The movable focusing means comprising two substantially identical cylindrical focusing coils 179A, 179B having a generally rectangular shape in cross-section and having a central opening 181, two pairs of parallel outer side surfaces 183, 185 and 187, 189, two pairs of inner side surfaces 191, 193 and 195, 197 and outwardly facing axial end surfaces 199, 201, respectively, at the axially spaced ends of the coil. The scanning coil 155 is bonded with its outer side surface 159 against the free end 203 of the swing arm structure 137 in a position with its central axis 205 generally parallel to the scanning movements of the swing arm assembly 135 by suitable means such as adhesive means. Each focusing coil 179A, B is being bonded at a portion of its outwardly facing axial end surface 199 at one side of its central opening 181 against the outer side surface 161 of the scanning coil 155 remote from the swing arm structure 137 by suitable bonding means such as adhesive means, the two focusing coils 179A, B being disposed such that said portions of their outward facing axial end surfaces 199 are near to each other, parallel to each other, and generally parallel to the scanning movements of the swing arm assembly 135. Combined stationary magnetic means comprise an elongate permanent magnet means 207 facing the movable focusing coils 179A, B and spaced from the focusing coils 179A, B by an air gap, and further comprising a magnetically permeable stator 209 supporting the permanent magnetic means 207 and having a stator part 211 passing through the central opening 157 of the scanning coil 155 with play, the permanent magnet means 207 being magnetically polarized in a radial direction relative to the swing axis 145 of the swing arm assembly 135, and the arrangement being such that a substantially radially directed permanent magnetic field is set up across the air gaps present between the scanning coil and the stator part 211 and between said parts of the focusing coils 179A, B and the stator 209. In accordance with the invention, the stationary magnetic scanning means 207-211 are rigidly associated with the magnetic motor stator of the spindle motor 133. In accordance with a further feature of the invention, the motor stator of the spindle motor 133, the scanning stator core part 211, the stationary pivoting means 153, and the focusing stator core 209 are integrated into a combined stationary unit. This stationary unit is made from a suitable magnetically permeable material such as soft iron and comprises a temporarily removable part, the part 211, to enable insertion into the central opening 157 of the scanning coil 155. The stationary unit is provided with a supporting beam part having the same thickness as the remaining parts of the stationary unit 209, 211, 213 carrying the stationary pivoting means 153 at its free end and may be formed by a stack of stator laminations which may be integrated with the motor stator of the spindle motor 133.

Thus two optical disc apparatus 1 and 125 have been described according to a best mode for carrying out the invention contemplated by the inventor at the time of writing of the present specification. It will be appreciated by persons skilled in the art that the invention however is not limited by what has been particularly described and shown above. Many modifications are possible without departing from the inventive concepts herein. The swing arm structure 43 does not need to be rigid over its entire length and the focusing lens assembly could be mounted resiliently on a rigid part of the swing arm structure, the resilient mounting allowing focusing movements. The scanning pivoting means could be of a conventional fulcrum type. The focusing lens assembly could comprise a multiple component assembly including one or more relatively movable optical elements. The pivoting means could comprise swiveling means of gimbal type to provide both scanning and focusing movements. Separate scanning and focusing structures could be provided associated with the spindle motor. The optical means could be provided partly on the supporting structure while being optically and/or electrically coupled with the focusing lens assembly, etc. All these and other embodiments may be combined with the main feature of the invention, which is to have the stationary magnetic scanning means and possibly also the stationary magnetic focusing means and/or the stationary pivoting means rigidly associated with the magnetic motor stator.

1. Optical disc apparatus (1; 125) for recording and/or reproducing information on/from an information surface (3; 129) of a rotatable optical disc (5; 127), comprising:
a supporting assembly (7; 131);
a motor (9; 133), associated with the supporting assembly (7; 131), for rotating the optical disc (5; 127) about a spindle axis (13; 134) and having a magnetic rotor (15) and a magnetic motor stator (17) magnetically cooperating with each other across an intermediate air gap (19);
optical means associated with the supporting assembly (7; 131) for scanning an information surface (3; 129) of said optical disc (5; 127) and comprising a focusing lens assembly (29, 33; 139, 141) having a movable focusing lens (29; 139) having a focusing axis (35; 143), said focusing lens assembly (29, 33; 139, 141) being movable in an axial direction along said focusing axis (35; 143) for focusing an optical beam (42) on said information surface (3; 129) of said optical disc (5; 127);
a swing arm assembly (41; 135) comprising a generally elongated swing arm structure (43; 137) mounting said focusing lens assembly (29, 33; 139, 141) near a free end (45; 203), the swing arm assembly (41; 135) being pivotally rotationally movable about a swing axis (47; 145) remote from said free end (45; 203) and directed generally perpendicularly to the swing arm structure (43; 137) and generally parallel to said spindle axis (13; 134) and said focusing axis (35; 143), such that the swing arm assembly (41; 135) rotationally sweeps a scanning plane generally parallel to said information surface (3; 129) of the mounted optical disc (5; 127), the swing arm assembly thereby causing said focusing lens assembly (29, 33; 139, 141) to scan over the information surface (3; 129) of a mounted optical disc (5; 127);
rotational pivoting means (49, 51, 53; 149, 151, 153) for enabling said rotational scanning movements of the swing arm assembly (41; 135) and comprising stationary pivoting means (49; 153) associated with the supporting assembly (7; 131) and movable pivoting means (51, 53; 149, 151) associated with the swing arm structure (43; 137) pivotally cooperating with the stationary pivoting means (49; 153);
movable magnetic scanning means (55, 57; 155) provided at the free end (45; 203) of the swing arm assembly (41; 135) for driving said swing arm assembly (41; 135) rotationally about said swing axis (47; 145);
stationary magnetic scanning means (59, 75, 77; 207, 209, 211) associated with the supporting assembly (7; 131) and comprising a magnetic scanning stator core (59; 207) provided near and spaced from the free end (45; 203) of the swing arm assembly (41; 135) for magnetically cooperating with said movable magnetic scanning means (55, 57; 157) across at least one intermediate air gap (61) disposed in a curved plane (63);
wherein the stationary magnetic scanning means (59, 75, 77; 207, 209, 211) are rigidly associated with the magnetic motor stator (17; 133).

2. Optical disc apparatus (1; 125) according to claim 1, wherein the motor stator (17; 133) and the scanning stator core (59; 209) are integrated into a combined stationary unit (17, 59; 133, 209).

3. Optical disc apparatus (1; 125) according to claim 1, wherein also the stationary pivoting means (49; 153) are rigidly associated with the magnetic motor stator (17; 133).

4. Optical disc apparatus (1; 125) according to claim 2, wherein the motor stator (17; 133), the scanning stator core (59; 209) and the stationary pivoting means (49; 153) are integrated into a combined stationary unit (17, 49, 59; 133, 153, 209).

5. Optical disc apparatus (1; 125) according to claim 1, wherein the optical disc apparatus further comprises:
focusing guide means for enabling the axial focusing movements of the focusing lens assembly (29, 33; 139, 144) along said focusing axis (35; 143);
movable magnetic focusing means (55, 57; 179A, B) provided at the free end (45; 203) of the swing arm assembly (41; 135) for axially driving said focusing lens assembly (29, 33; 139, 141) along said focusing axis for focusing an optical beam on the disc information surface (3; 129);
stationary magnetic focusing means (75, 77; 207) associated with the supporting assembly (7; 131) and comprising a magnetic focusing stator core (59; 209) provided near and spaced away from the free end (45; 203) of the swing arm assembly (41; 135) for magnetically cooperating with the said movable magnetic focusing means (55, 57; 179A, B) across at least one intermediate air gap (61) disposed in a curved plane (63);
wherein the stationary magnetic focusing means (75, 77; 207) are rigidly associated with the magnetic motor stator (17; 133).

6. Optical disc apparatus (1; 125) according to claim 4, wherein the motor stator (17; 133), the scanning stator core (59; 209), the stationary pivoting means (49; 153) and the focusing stator core (59; 209) are integrated into a combined stationary unit (17, 49, 59; 133, 153, 209).

7. Optical disc apparatus (1; 125) according to claim 2, wherein the combined stationary unit (17, 49, 59; 133, 153, 209) comprises a stator packet assembled from magnitizable individual stator laminations (69, 71, 73).

8. Optical disc apparatus (1) according to claim 7, wherein:
the movable magnetic scanning means comprise permanent magnetic rotationally movable scanning means (55, 57),
the stationary magnetic scanning means comprise a number of individual stator coils (75, 77) arranged on the stator core (59) in a serial arrangement along the rotational scanning path (63) of the movable permanent magnetic scanning means (55, 57),
electronic commutating means (115) being provided to selectively switch stator coils (75, 77) on and off,
scanning sensor means (79) being provided for detecting, and scanning control means being provided for controlling the rotational position of the arm structure (43) respectively, by controlling the current amplitude and direction in each of the stator coils (75, 77) which has been selectively switched on in order to control the rotational arm position and movements.

9. Optical disc apparatus (1) according to claim 8, wherein:
the movable magnetic focusing means comprise permanent magnetic axially movable focusing means (55, 57) and
the stationary magnetic scanning means and the stationary magnetic focusing means comprise a number of individual stator coils (75, 77) arranged on the stator core (59) in a serial arrangement along the rotational scanning path (63) of the movable permanent magnetic scanning means (55, 57) and distributed over two axially spaced levels,
focusing sensor means being provided for detecting, and focusing control means being provided for controlling the axial focusing lens position respectively by controlling the current amplitude and direction in each of the stator coils (75, 77) which have been selectively switched on in order to control the axial focusing lens (33) position and movements.

10. Optical disc apparatus (1) according to claim 9, wherein:
the stator coils (75, 77) in each of the two levels are spaced at a constant pitch on the stator core (59) along the path (63) rotationally swept by the movable magnetic scanning means (55, 57) and movable magnetic focusing means (55, 57),
the stator coils (75, 77) in the two levels are arranged in planes parallel to the scanning plane of the scanning arm structure (43) and
the stator coils (75) present in one level are positioned between the stator coils (77) present in the other level.

11. Optical disc apparatus (1) according to claim 8, wherein biasing means (99; 55, 57, 105, 107) are provided to bias the magnetic force of attraction produced between the movable permanent magnetic scanning and/or focusing means (55, 57) and the motor stator (17), magnetic adhesion of the scanning arm structure (43) to the motor stator (17) being prevented in a rotationally extreme position of the scanning arm structure (43) nearest to the spindle motor.

12. Optical disc apparatus (1) according to claim 11, wherein:
the stator core (59) is provided with stator teeth,
the stator coils (75, 77) are wound on the stator teeth (105, 107) and
the biasing means are provided by one or more stator teeth (105, 107) on said stator core (59), positioned such that in said extreme rotational position of the scanning arm structure the rotational magnetic pull (P) of said one or more stator teeth (105, 107) exceeds the rotational magnetic pull of the motor stator (17).

13. Optical disc apparatus (125) according to claim 1, wherein:
the movable magnetic scanning means comprise a cylindrical scanning coil (155) having a generally rectangular shape in cross section and having a central opening (157), two pairs of parallel outer side surfaces (159, 161-163, 165), two pairs of inner side surfaces (167, 169-171, 173) and outwardly facing axial end surfaces (175, 177) at the axially spaced ends of the coil (155),
the movable focusing means comprising two cylindrical focusing coils (179 A, B) which have a generally rectangular shape in cross-section and have a central opening (181), two pairs of parallel outer side surfaces (183, 185-187, 189), two pairs of inner side surfaces (191, 193-195, 197) and outwardly facing axial end surfaces (199, 201) at the axially spaced ends of the coil (179 A,B),
the scanning coil (155) being bonded with one of its outer side surfaces to the free end (203) of the swing arm structure (137) in a position with its central axis (205) generally parallel to the scanning movements of the swing arm,
each focusing coil (179 A, B) being bonded at a part of one of its outwardly facing axial end surfaces (199) on one side of its central opening (181) against the outer side surface (161) of the scanning coil (155) which is remote from the swing arm structure (137), the two focusing coils (179 A, B)being disposed such that said parts of their outwardly facing axial end surfaces (159)are near to each other, parallel to each other and generally parallel to the scanning movements of the swing arm,
the combined stationary magnetic means comprising an elongated permanent-magnet means (207) facing the movable focusing coils (179 A, B) and spaced from the focusing coils (179 A, B) by said air gap, and further comprising a magnetically permeable stator (209) supporting the permanent-magnet means (207) and having a stator part (211) passing through the central opening (157) of the scanning coil (155) with play, the permanent magnet means (207) being magnetically polarized in a radial direction relative to the swing axis (145) of the swing arm assembly (135) and the arrangement being such that a substantially radially directed permanent magnetic field is set up across said air gap.
